(19) United States
(12) Patent Application Publication
(10) Pub. No.: US 2008/0028220 A1
(43) Pub. Date: Jan. 31, 2008

(54) Method and System for Verifying Documents

(75) Inventor: Hans Wyssen, Zurich (CH)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: The Thayn Firm, Limited Liability Company, a Limited Liability Company

(21) Appl. No.: 10/582,831

(22) PCT Filed: Dec. 7, 2004
(86) PCT No.: PCT/IB04/52685

§ 371 Date: Apr. 12, 2007

Related U.S. Application Data
(60) Provisional application No. 60/481,786, filed on Dec. 14, 2003.
(60) Provisional application No. 60/521,579, filed on May 27, 2004.

(51) Int. Cl. H04L 9/00

(52) U.S. Cl. 713/176

(57) ABSTRACT

A method and system for verifying the authenticity documents using an international computer network. Documents are processed by a central repository (100) and verification information supporting their authenticity generated. Paper documents are scanned into electronic image data and uploaded to a server (101) together with verification information where they can be viewed by persons using client computers (301, 302) on an international computer network such as the Internet (400).

### FIELD OF THE INVENTION

This invention relates to authenticating an original document through the use of electronic image signals corresponding to the document.

### BACKGROUND OF THE INVENTION

In recent years, communication has been increasingly carried out online over the internet. However, it is difficult to determine if the business or person with whom one is corresponding with online is bona fide. In an effort to establish their credentials online, individuals and businesses often scan diplomas, certificates, permits and the like into electronic image data and display these on web pages at websites. But such electronic images have not proven trustworthy since electronic images can easily be manipulated, and the viewer of such images cannot be certain if such images are trustworthy. There exists therefore a pressing need for persons and businesses to establish their credentials in an online environment.

Additionally, paper documents are increasingly being scanned and the resulting electronic documents stored on machine readable medium including, but not limited to, floppy diskettes, optical disks, CD-ROMs, and magnet-optical disks, ROMs, RAMs, EPROMs, EEPROMs, magnet or optical cards, or other type of media/machine-readable medium suitable for storing electronic documents. Electronic documents are increasingly being distributed using the afore-mentioned machine-readable media, as well as by electronic mail over computer networks such as the Internet. It is well known that modern graphic software programs can be used to fraudulently manipulate documents and even produce authentic looking stamps, seals, signatures which are virtually impossible to detect when viewing electronic documents with a computer monitor. Therefore, when viewing electronic documents it is very difficult to know if signatures, stamps, seals and the like are original, that is, were actually applied to the paper document which was scanned into an electronic document. For example, if the original paper document was notarized, it is difficult or even impossible for a person viewing and electronic image of the document to determine if the notary signature or notary seal were actually applied to the paper document which was scanned.

Furthermore, due to advances in computerized printing technologies it has become easier to produce fraudulent paper documents. For example, it can even be difficult for a person, when examining an original paper document, to determine if ink stamps, signatures and the like are original, that is, if they were manually applied to the document or if they where fraudulently applied to the document using printing automation, such as, for example, a high resolution color inkjet printer. The same problem arises when viewing document images which were transmitted via fax or facsimile devices.

Due to the aforementioned, there exists a pressing need for persons viewing electronic documents as well as hard copy documents to be able to verify the authenticity of such documents. Also, there exists a need for an improved method for persons and businesses to establish their credentials online.

A prior art method of using the post or courier to mail original paper documents or notarized copies thereof to a plurality of parties suffers from the following problems:
is slow and in stark contrast to today's realities where correspondence is increasingly being carried out using electronic mail.
providing original paper documents such as notarized copies is expensive especially when sent to multiple recipients.

### SUMMARY OF THE INVENTION

In accordance with the invention in a first aspect, there is provided a computer system accessible remotely by a user to authenticate a document, comprising: a memory configured to store electronic image data corresponding to an original document having a verifiable provenance, and separately derived electronic displayable verification information corresponding to the provenance of at least part of the original document, and an output configured to provide said image data and said verification information for display by the user to authenticate the original document.

The invention enables users to check, online, the authenticity of original documents paper documents, including paper copies in a manner which:
substantially speeds up communications by allowing persons to check documents online rather than relying on certified paper documents which must be physically transported. For example, persons may check, online, documents supporting the trustworthiness of an online business such as, for example, an internet auction seller.
substantially lowers the cost of allowing a plurality of persons to view notarized or certified documents since a single certified or notarized sheet paper document which has been processed according to the present invention can be viewed online by a plurality of persons. For example, with the method and system of the present invention it is not necessary to produce and mail a plurality of notarized paper documents to a plurality of persons.
increases security since documents may be verified by an additional party.

The invention also includes a method of displaying a document for authentication, comprising creating electronic image data corresponding to an original document having a verifiable provenance, providing electronic, displayable verification information corresponding to the provenance of at least part of the original document, and displaying the image data and the verification information, whereby to permit a user to authenticate the document.

The image data may have been obtained from an authenticated source, and the verification information may include data corresponding to the provenance of the authenticated source.

The image data and the verification data may be under the control of a repository such that neither users or owners of the original document can change its associated image data and verification information.

The verification information may comprise data concerning the provenance that has been subjected to authentication by the repository, and the verification information may be configured to signal to the user that the repository provides such authentication.

The invention further includes an electrical signal for displaying a document for authentication to be received by a client computer operated by a user who wishes to authenticate the document, comprising electronic image data corresponding to an original document having a verifiable provenance, and electronic, displayable verification information corresponding to the provenance of at least part of the original document.

### BRIEF DESCRIPTION OF THE DRAWINGS

In order that the invention may be more fully understood embodiments of the invention will now be described by way of illustrative example with reference to the accompanying drawings in which:

FIG. 1 is a schematic block diagram of a network including a repository and a repository agent in accordance with the invention,

FIG. 2 illustrates an exemplary electronic document page to which verification information has been added,

FIG. 3 illustrates an example of verification information which has been added to a signature and a seal which appear on an electronic document,

FIGS. 4 to 6 illustrate exemplary electronic pages with document verification information,

FIGS. 7 and 8 illustrate exemplary methods of referring or linking to electronic document images which are stored on the repository's server from electronic pages including web-pages,

FIG. 9 illustrates an example of a paper photocopy of a document to which text is added referring to a document which is stored on the repository's web server,

FIG. 10 illustrates an exemplary electronic document page to which verification information has been added,

FIG. 11 illustrates an exemplary electronic document page to which verification information has been added,

FIG. 12 illustrates an exemplary electronic document page to which verification information has been added, and

FIG. 13 illustrates a transmittal sheet for a certified copy of an original document.

### DETAILED DESCRIPTION

The present invention relates generally to the hosting of electronic documents together with verification information supporting their authenticity on a server which is accessible by client computers on an international computer network environment. Paper documents are processed by a repository and scanned into electronic image data. Paper documents are also examined and document verification information specific to each document generated. Electronic image data generated from paper documents is uploaded together with corresponding verification information to a web server so that persons using client computers can view electronic images of selected documents as well as accompanying verification information.

Verification information may include, but is not limited to:
1) signatures, ink stamps, seals and the like that were manually applied to the original paper document which was scanned and uploaded.
2) evidence that the institution which issued the document is bona fide.
3) evidence that information the document contains is accurate and true.

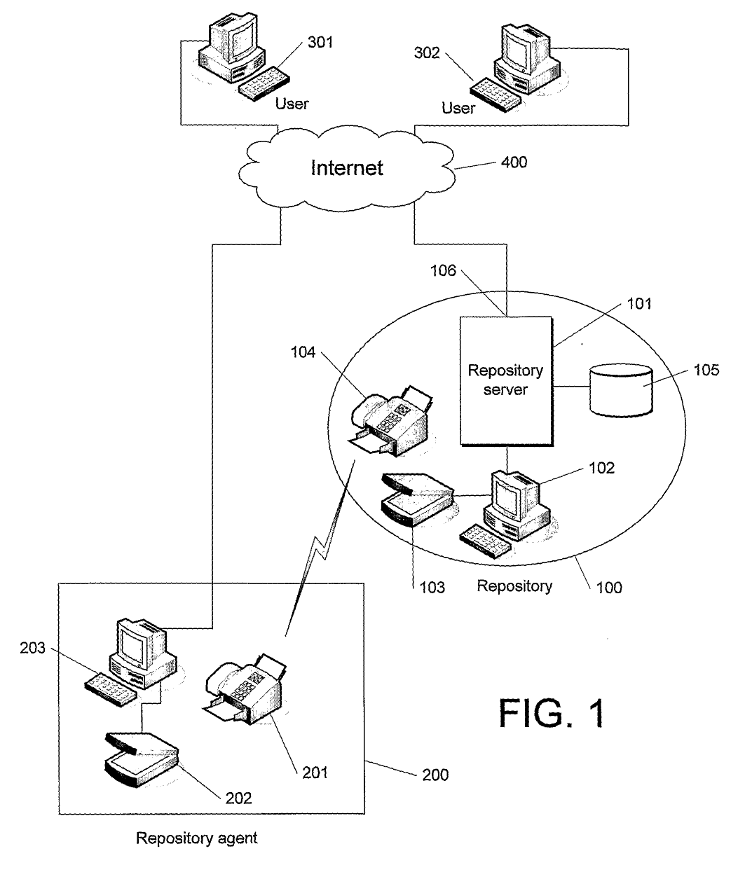

The present invention may be implemented in the form of an internet based service and an example will now be described with reference to FIG. 1.

Paper documents including, for example, certificates, diplomas, deeds, contracts, photos, legal documents and the like are collected by a central repository 100. The repository can be an individual, a company, a governmental entity, an institution, an association or some other organization. The central repository 100 and/or its members may also have certain legal qualifications.

For example the central repository 100 may have one or more representatives or agents such as repository agent 200, shown in FIG. 1 by way of illustration, which may be located remotely from the central repository 100. The repository representatives or agents may include public notaries or institutions which issue documents, such as for example, schools which issue diplomas.

The paper documents are scanned into electronic image data using a scanner in a manner known per se in the art and the resulting electronic images are uploaded to one or more servers where they can be viewed online by users wishing to authenticate the documents concerned i.e. persons with client computers 301, 302 which are connected to the repository through a computer network, e.g. an international computer network, preferably the Internet 400. It will be appreciated that the computers 301, 302 can be located remotely of the repository 100 and the agents 200, at any convenient location.

In this example, the repository 100 includes a repository server 101 which hosts a repository web site, accessible through the Internet 400. Although shown located at the repository 100, the repository server 101 can be at any convenient location. The server 101 is controlled by a personal computer 102 with an associated document scanner 103. Thus, a paper document such as a diploma, certificate, or a notarized copy of a document or the like can be scanned using the scanner 103 and posted to the web site of the central repository 100, to be accessed for authentication purposes by users 301, 302 through the Internet 400.

The document to be uploaded to the repository web site can also and may preferably be supplied through the intermediary of the repository agent 200. To this end, the repository agent 200 includes a facsimile machine 201 for scanning the paper document and sending it to a secret telephone number associated with a facsimile machine 104 at the central repository 100. The facsimile transmission may be accompanied by an unique code on a cover sheet to identify and authenticate the source of the facsimile transmission to the repository 100. The faxed copy of the document can, after receipt at the facsimile machine 104, be scanned using scanner 103 and posted to the repository website as previously described.

The server 101 is of a conventional hardware design well known per se to those in the art and includes a processor and associated memory 105 for storing the electronic image data corresponding to documents to be accessed through the hosted website, together with the verification information. The server 101 has an output connection 106 coupled to the Internet 400 to allow communication between the user client computers 301, 302.

Alternatively, the document can be scanned using a scanner 202 coupled to a computer 203 at the repository agent 200, and image data corresponding scanned document can be sent to the computer 102 at the central repository 100, for example as an email sent through the Internet 400 as an email attachment. The email communication may be made through a secure link and may be encrypted according to encryption techniques well known per se in the art to protect the document from corruption and unauthorized manipulation and also to uniquely identify and authenticate the sender to the repository.

In accordance with the present invention, the paper documents which are scanned are carefully examined, by a verification authority, preferably the repository or the repository agent and verification information generated. The resulting verification information is made available to the persons who view selected scanned documents online, for example through the use of computers 301, 302 which can run web browsers for this purpose. Verification information which appears together with documents enables persons to view, online, evidence supporting the authenticity of selected documents. For example, with the method and system of the present invention, a paper photocopy of a document or electronic image of the document may be verified online.

The repository 100 can thus provide a service to consumers wishing to authenticate documents in such a way that precludes the owner of the document or others from tampering with electronic documents and verification information. Persons wishing to check the authenticity of a paper photocopy of a document or an electronic image of a document can visit the web site of the repository 100 and view the image of the electronic document stored there, as well as verification information attesting to the authenticity of the document.

Verification information can relate to one or more elements of the document. For example verification information may relate to but not be limited to the following elements:
a) Marks including, but not limited to, signatures, seals, date stamps, ink stamps, embossing and the like are original. Original means that the mark was manually applied to the paper document which was sent to the repository. An example of an original mark is a signature that was applied by hand using a writing instrument and not with a computerized printing device such as an ink jet printer. Marks that can be flagged include original signatures and stamps which were applied to the paper document by a public notary, legal office or governmental office.
b) Research giving credibility to persons or institutions named in the document. For example the school which issued the document or the public notary which notarized the document. It is well known that there are many fake or bogus schools which simply sell fake diplomas and certificates.
c) Research showing that the information contained in the document is accurate. For example, in the case of a diploma, that a certain person graduated on the given date and received a certain credit or degree.
d) The contact information of one or more persons or institutions mentioned on the document as well as the owner of the document. Contact addresses can be contacted by persons who require further information about a document. For example, the contact information of the institution which issued the document or the public notary which notarized the document may be displayed.
e) A signed declaration or oath by the owner of the document attesting to its authenticity and accuracy. The signature of the owner making the declaration may also be notarized. Original marks on the declaration may also be flagged as explained in point “a” of this list.
f) A signed declaration or oath by the repository or representative thereof attesting to its authenticity and accuracy. This declaration may be notarized. Original marks on this declaration may also be flagged as explained in point “a” of this list.

Additional verification information which may appear together with documents includes but is not limited to one or more items from the following list:
The date when the electronic document was uploaded to the web server. This is a time stamp showing that a particular document existed at a certain time.
Until what date the document will be available for viewing on the repository's server.
The name and contact information of the owner of the electronic document.
Table of contents. This is particularly useful if the owner has a plurality of documents stored at the repository.
Copyright information as well as terms of use of the repository.
Information about the services offered by the repository.

Verification information may be presented to online viewers in various ways including, but not limited to, the following:
appear on the electronic document image of the scanned document as a symbol, stamp or text message. If text boxes are used, it is preferable that they can be opened or closed so as not to interfere with the view of the document. For example pop-up text boxes may be used.
appear on one or more separate pages.

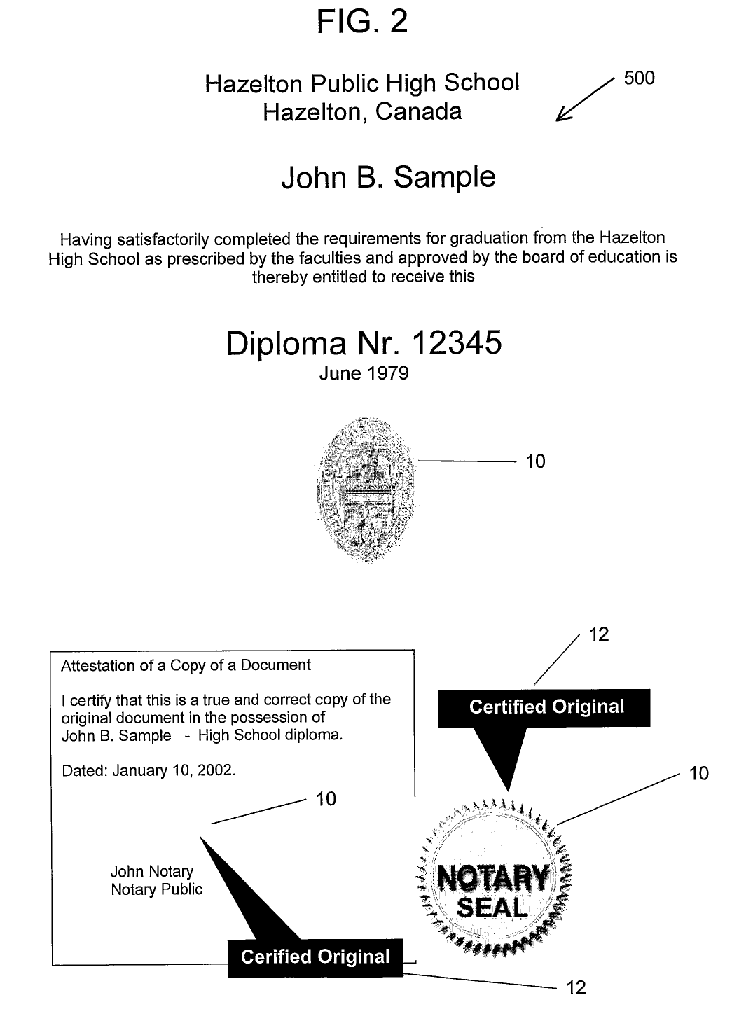

FIG. 2 illustrates an example of an electronic document image 500 posted to the repository web site, which was produced by the repository 100 or by the repository agent 200 by scanning an original paper document as previously described. Verification information inserted by the repository 100 onto the electronic image data appears as indicia 12. Marks 10 which include signatures, seals, date stamps, ink stamps, embossing that were manually applied to the paper document that was scanned, are flagged with indicia 12 so that persons viewing the electronic document online are informed which marks 10 are original.

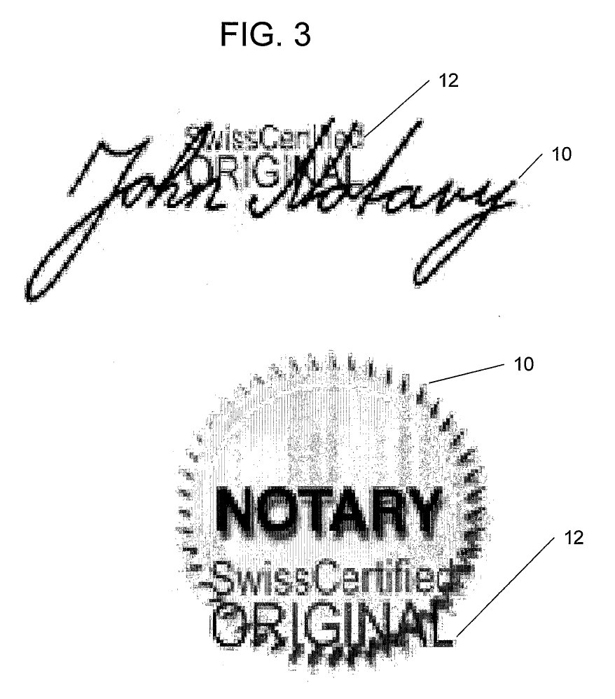

It is preferable that indicia 12 be a distinctive marking so that its meaning is easily discernible for the viewer. For example, indicia 12 may include the word “original” as well as the logo and/or name of the repository. Indicia 12 may include further information about mark 10 such as, for example, an original signature, original stamp, or original seal. Indicia 12 may be applied beside mark 10 as shown in FIG. 2, or over mark 10 as shown in FIG. 3 where verification information, indicia 12, has been inserted over a signature and over a seal. Indicia 12 may be opaque or translucent so as not to entirely block out mark 10. To make indicia 12 more visible it is preferable to scan documents in black and white or greyscale and indicia 12 contain color so as to stand out, for example, red.

Indicia 12 may take various forms, for example, mark 10 may be highlighted with a certain color or pattern. Indicia 12 may include a geometric form, such as for example, a circle, square and so on or may be text only. Indicia 12 may also be, for example, a text box or a pop-up text box which can be closed or opened, thereby not interfering with the view of mark 10. The purpose of indicia 12 is simply to indicate which mark 10 is an original signature, ink stamp, date stamp, seal or the like, which was applied to the paper document that was scanned and uploaded to the repository web server 101. Marks 10 which were photocopied or printed to the paper document which was scanned would not be flagged with indicia 12. FIG. 2 shows one mark 10 which was not flagged with indicia 12 because it was not original but rather a photocopy.

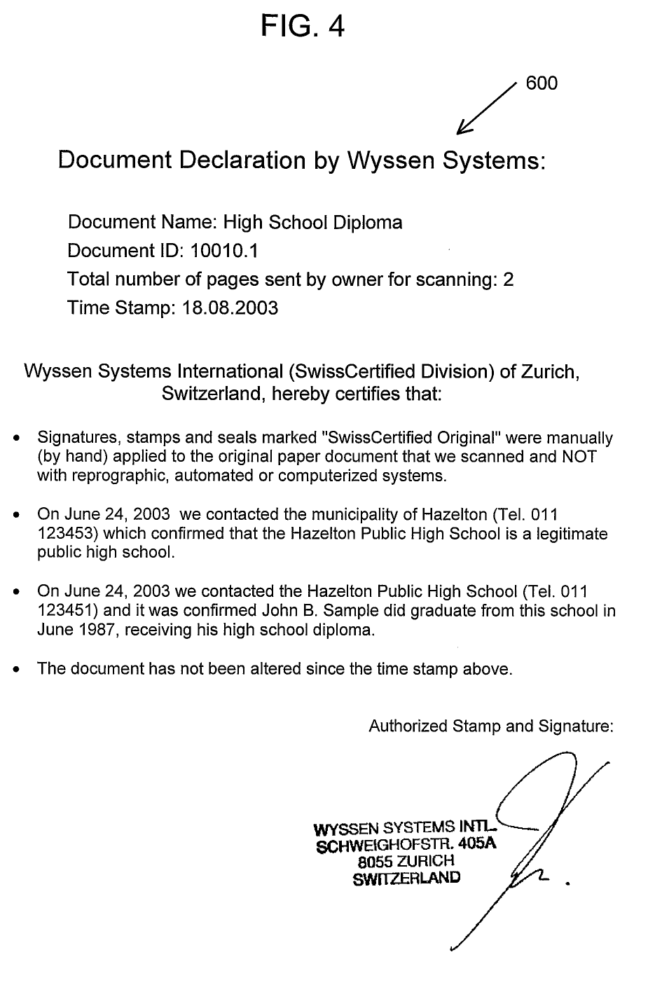

FIG. 4 shows an exemplary page with verification information 600 provided by the repository 100. This page appears together with the electronic document when viewed online. As shown in FIG. 4 this may include details of verification information generated for a specific document as well as an official declaration by the repository 100 attesting to the accuracy of verification information generated.

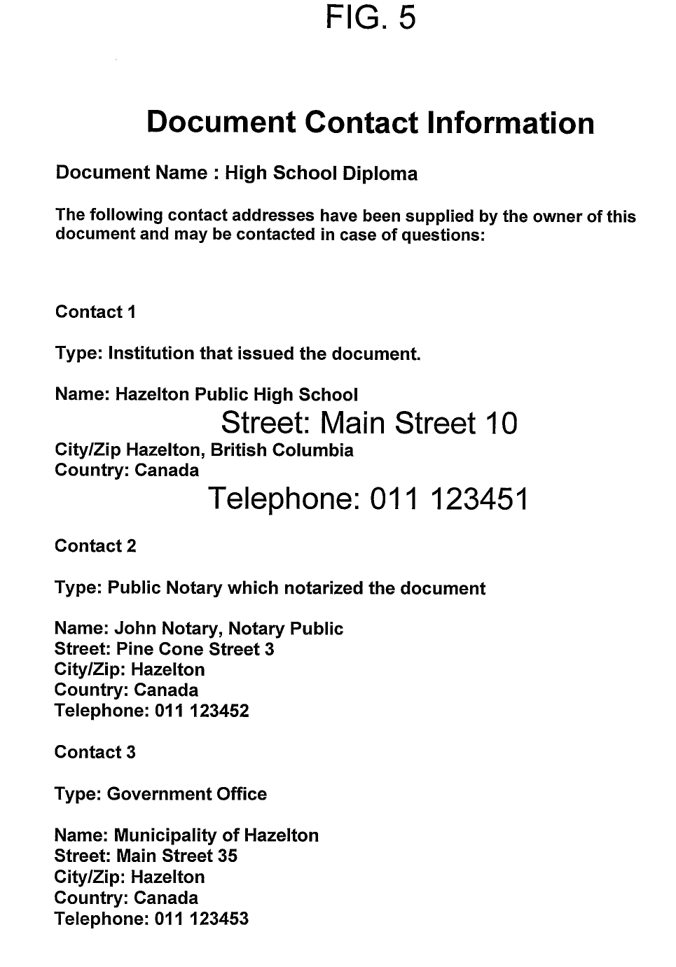

FIG. 5 shows an exemplary page with verification information provided by the owner of the document. This page appears together with the electronic document when viewed online. As shown in FIG. 5, this can include contact information of persons and institutions named in the document. Such contact addresses may be contacted by viewers who have questions about the document.

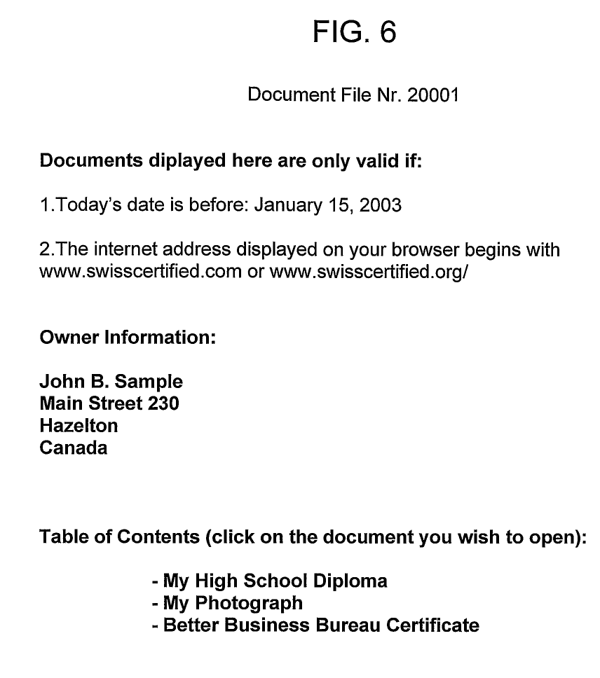

FIG. 6 shows an exemplary electronic cover page with verification information which may appear with one or more documents belonging to the same owner. As shown in FIG. 6 the verification information can inform the online viewer until what date the document(s) will be available for viewing on the server and that the document images are not valid unless viewed at the repository's web site. Contact information of the owner of the documents can also be included, as well as a table of contents listing the names of documents available for viewing.

In the following example, the repository 100 provides verified document hosting services to a plurality of individuals and businesses. Paper documents are collected by the repository 100 or the agent 200. If the paper document is sent by mail it is preferable not to send the original document to the repository but rather a notarized or certified true copy since documents may be lost or damaged in the mail.

Since in the preferred embodiment verification information includes the flagging of marks 10 which are original, it is preferable to send documents to the repository which include original marks 10 which would subsequently be flagged with indicia 12.

Before sending a paper document to the central repository 100 the consumer will determine which certifying authority should manually apply marks 10 to the paper document as originals which would be flagged by the central repository with indicia 12.

Among the factors which will play a role in determining who should apply marks 10 in an original form are:
The geographical location of the party who desires to view the certified document. For example, it may be required that the document be notarized by a public notary from a certain country or state.
The type of certification. In the case of a school diploma it would be advantageous that the certifying authority be the school which issued the diploma. In other cases where only a timestamp or proof that a document existed at a certain time, as in the case of intellectual properties, a public notary or the date when the repository uploaded the document will suffice. If a photograph is to be certified as a true likeness of a certain individual, a public notary, medical doctor, or other certifying agent may certify this by comparing the photograph with the photograph in an official document such as a passport or driver's license.
The requirements of those wishing to view a certified document. For example, the party wishing to view the certified document, online, may require that certain documents such as a birth certificate are stamped by a specific government agency. In other cases the document may be certified or witnessed by, for example, a medical doctor, judge or bank officer. In other cases a certified true copy by the institution which issued the document may be required.

In order to determine which marks 10 on the paper documents are original and consequently flagged with indicia 12, the repository 100 may use, for example, magnification. For example, if a signature was manually applied to the paper document using a writing instrument, magnification would reveal depressions in the paper which would not occur if the signature had been printed with an inkjet printer. If a non-ink pressure stamp embossing seal has been applied to the paper document it is preferable that this be made visible on the electronic document.

One effective method to do this is to lightly rub over the embossing with the side of a pencil before scanning. If the paper document has been marked with ultraviolet or infrared ink it is desirable to expose the paper document to ultraviolet or infrared radiation during the scanning process so that any such markings are also visible in the resulting electronic document.

Marks 10 which meet the criteria of being original are marked with indicia 12 in the uploaded electronic document.

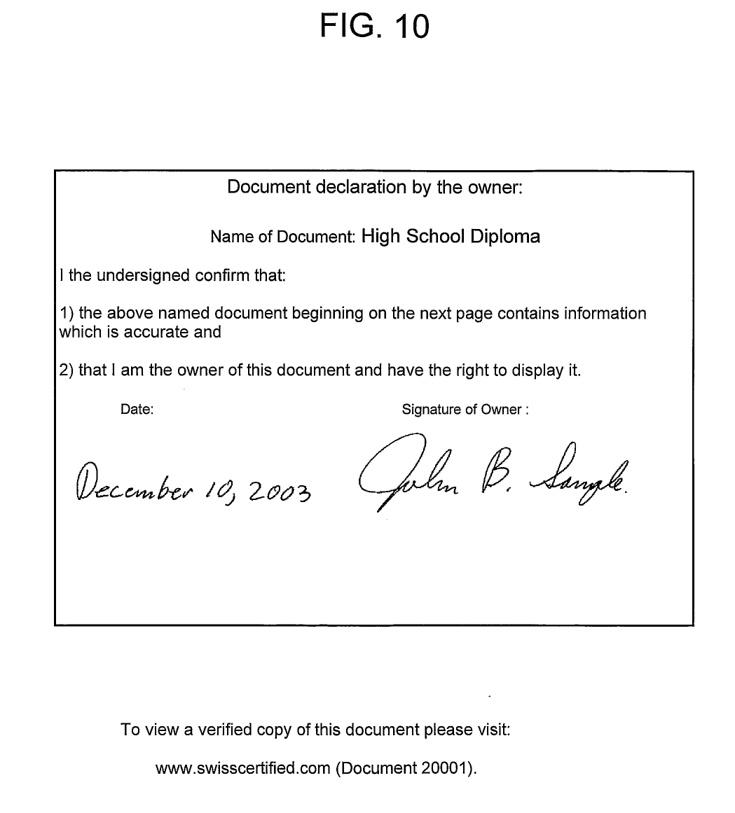

Consumers may provide additional verification information along with paper documents that they send to the repository for uploading. Such information is preferably also made available to online viewers as verification information. This may include, but not be limited to:
contact addresses of individuals or institutions named in the document for example, the contact information of the institution which issued the document or the public notary which notarized the document. This information may appear as verification information when viewed online as shown in FIG. 5. People who view the document online may then contact such addresses for further information.
a declaration by the owner of the document stating that the document is accurate, belongs to the owner and that the owner has the right to display it. FIG. 10 illustrates an example of such a declaration. The statement may be signed by the owner and the signature notarized. Marks 10 which are original on this declaration document may also be flagged with indicia 12.

Additionally, the repository may, as shown in FIG. 4, include a document report which is also made available to online viewers as verification information. The report may include, but not be limited to, the following:
A statement verifying that only marks 10 which were manually applied to the scanned paper document were flagged with indicia 12 and that the document has not been altered since the date it was uploaded.
Research results verifying the accuracy of the document. For example the repository may contact one or more of the contact addresses that the owner provided and report the results.

After the paper documents have been processed by the repository 100 they can either be returned to their respective owners or destroyed.

At present, the preferred format for storing electronic documents on the web server of the repository is the PDF format. This format has gained widespread acceptance among authors, distributors, and publishers. Portable Document Format (PDF) developed by Adobe Systems, Inc. of San Jose, Calif. PDF is a page description file format which describes the visual appearance of a document's physical page, including fonts and special characters, images, and layout. PDF keeps the design of a page fixed and communicates the physical structure through visual cues such as fonts and font size, indentation, and placement on a page or screen. Further, PDF allows for sophisticated typography, non-Roman alphabets, and mathematical and chemical equations. Thus, PDF files are well suited for storing electronic documents on the web server.

A desirable feature of the PDF format is that a plurality of pages can be stored in one document file. For example, a plurality of electronic documents belonging to one consumer as well as accompanying pages with verification information may be stored in one PDF file.

A suitable method for applying indicia 12 to electronic documents is the “stamp tool” in the Adobe Acrobat PDF editing program. While this method has been found to be suitable, other methods may also be used. For example, before scanning, the paper document may be stamped by hand with an ink stamp to produce indicia 12 so that when the resulting paper document is scanned, indicia 12 is visible in the resulting electronic image file.

In Adobe Acrobat, the “note tool” can also be used to insert verification information to electronic documents. The “note tool” message can be closed so as to avoid interfering with the view of the document. The PDF format also allows verification information to be embedded as audio and video messages. For example, a video or sound track of an individual receiving the diploma displayed in the PDF file may be made available to online viewers. In another example a letter of recommendation by a former employer may include a sound track from a former employer recommending the person.

The plurality of pages of electronic documents and pages with verification information can be stored in one PDF file, and navigational aids can be inserted. For document files which are in the PDF file format this can include one or more of the following:
PDF bookmarks: This feature is supported in PDF readers such as Adobe Acrobat Reader where so called bookmarks are listed in a separate frame. Bookmarks may be linked to individual documents or pages with verification information within a document file. A bookmark may, for example, be named after the document to which it is linked. For example: “My Photo” or “High School Diploma”.
Hyperlinks may also be used within a PDF document file. For example a cover page with a table of contents, as illustrated in FIG. 6, can include hyperlinks to the enclosed documents.

In the preferred embodiment, document files are stored on a server as individual files with unique identifying file names. The name of the document file may be numeric, alphabetic or alphanumeric. For example: “20001.pdf”.

In the preferred embodiment persons can view selected electronic documents using remote computers which are connected to the internet using web browser software such as, for example, Microsoft Explorer. Software plug-ins for viewing various graphic files including PDF are widely available for web browsers.

In the preferred embodiment, before the document file containing one or more electronic documents and information pages is uploaded to the server the following security features are applied to the PDF file:
No extraction of elements from the document including seals and pictures.
No changing of the document.

Other security features which may be added include:
User password for opening the document. This will prevent unauthorized persons from viewing the document. This can be optional depending on the needs of the owner of the document file.
Printing not allowed.
Master password for changing the document. This password is preferably only known by the repository 100.

It is also to be noted that new security features are being invented and that these may also be implemented. For example, new security features may include the following features:
not allow persons to redistribute or save document files to electronic media on a remote computer.
require separate open passwords for individual documents or pages within a PDF document file.
not permit a document to be opened after a certain expiry date.

After the paper documents are scanned they can either returned to their respective owners or destroyed.

Electronic files with documents and verification information are stored on the web server 101 for the repository 100, where they can be supplied as an electrical signal to be viewed using client computers 301, 302. In the preferred embodiment the website or URL (universal record locator) where the document images are stored belongs to the repository 100. For example the website may be at www.swisscertified.com. Due to security considerations, in the preferred embodiment, the server 101 where the documents are stored is protected with security as is known in the art. This may include, for example, a fire wall. SSL technology (Secure Sockets Layer) may also be used to create an encrypted link between the server and remote computers which connect to the web site of the repository in order to view certified documents.

It is important that the server be secured to prevent manipulation by anyone other than those authorized by the repository 100. People who view electronic documents on the server 101 must have the certitude that the documents have not been tampered with in any way by unauthorized persons including the owner.

In the preferred embodiment, the website of the repository 100 provided by the server 101 incorporates a user interface that enables persons to view selected electronic documents. For example, when visiting the web site of the repository, a person e.g. at user computer 301 or 302, wishing to view an electronic document in document file 20001.pdf may use a browser to access the web site hosted by the server 101, and enter the name of the document file “20001” in a form field on a web page. After pressing enter or clicking a button, the selected document file is supplied as an electrical signal to the client computer 301 or 302 and opened from within the web browser by the PDF reading plug-in, and the document file is opened. If the document file is protected with a password, the user is prompted for the password before the document can be opened.

It is to be noted that while PDF is the present preferred format for storing electronic documents on the computer server, known in the art are other file formats that may also be used. These include:

Tagged Image File Format (TIFF), JPEG, JPEG 12 Lossy, JPEG 12-8 Lossless, P-JPEG, Audio Video Interleave (AVI), (JPEG File Interchange Format) JFIF, Delrin Winfax, PCX (ZSoft Paint format), TGA (Truevision (Targa) File Format), Portable Network Graphics (PNG), DCX, G3, G4, G3 2D, Computer Aided Acquisition and Logistics Support Raster Format (CALS), Electronic Arts Interchange File Format (IFF), IOCA, PCD, IGF, ICO, Mixed Object Document Content Architecture (MO:DCA), Windows Metafile Format (WMF), ATT, Windows Bitmap Format (BMP), BRK, CLP, LV, GX2, IMG(GEM), IMG(Xerox), IMT, KFX, FLE, MAC, MSP, NCR, Portable Bitmap (PBM), Portable Greymap (PGM), SUN, PNM, Portable Pixmap (PPM), Adobe Photoshop (PSD), Sun Rasterfile (RAS), SGI, X BitMap (XBM), X PixMap (XPM), X Window Dump (XWD), AFX, Imara, Exif, WordPerfect Graphics Metafile (WPG), Macintosh Picture (PICT), Encapsulated PostScript (EPS), Graphics Interchange Format (GIF). Of course, as new image formats are introduced, it could be advantageous to use these as well.

Password programs are also widely available that can encrypt web content and pages so that they can only be viewed by authorized persons and also be protected against unauthorized manipulation.

While in the preferred embodiment images of paper documents are stored on the network server in individual document files, known in the art are other methods that can be used to make electronic documents together with verification information available for viewing with client computers within a server/client computer network such as the internet For example, images of documents and pages with verification information can be stored in one database file rather than in numerous separate files. This method has the advantage that rather than maintaining a complex file structure with potentially millions of separate files, an efficient database can be maintained that is designed to get information into memory quickly to provide fast access to the document images and verification information. Online users with client computers can select electronic documents which they wish to view as is known in the art.

In the preferred embodiment consumers are charged for services rendered by the repository 100. For example the repository may charge the consumer a fixed processing fee per document page. Such a processing fee can include the following services:
Scanning the paper document into an electronic format.
Analyzing the document for original signatures, stamps and seals and flagging such original marks with indicia 12 in the resulting electronic document image.
Hosting the electronic document and accompanying verification information on a web server.

The repository 100 can offer consumers additional services which may include one or more of the following:
Research services. For example investigating if an institution which issued the document is legitimate and verifying the accuracy of information contained in documents. The results are added to verification information which appears with the uploaded document. An exemplary page with research information is illustrated in FIG. 4.
Adding or deleting electronic documents from a consumer's document collection on the website provided by server 101.
Adding or changing security settings including passwords for opening documents.

The present invention can be used by consumers in various ways. After the paper documents have been processed into electronic documents and are uploaded together with verification information to the web server 101, their owners can allow selected persons or parties to view the verified documents at the website of the repository 100.

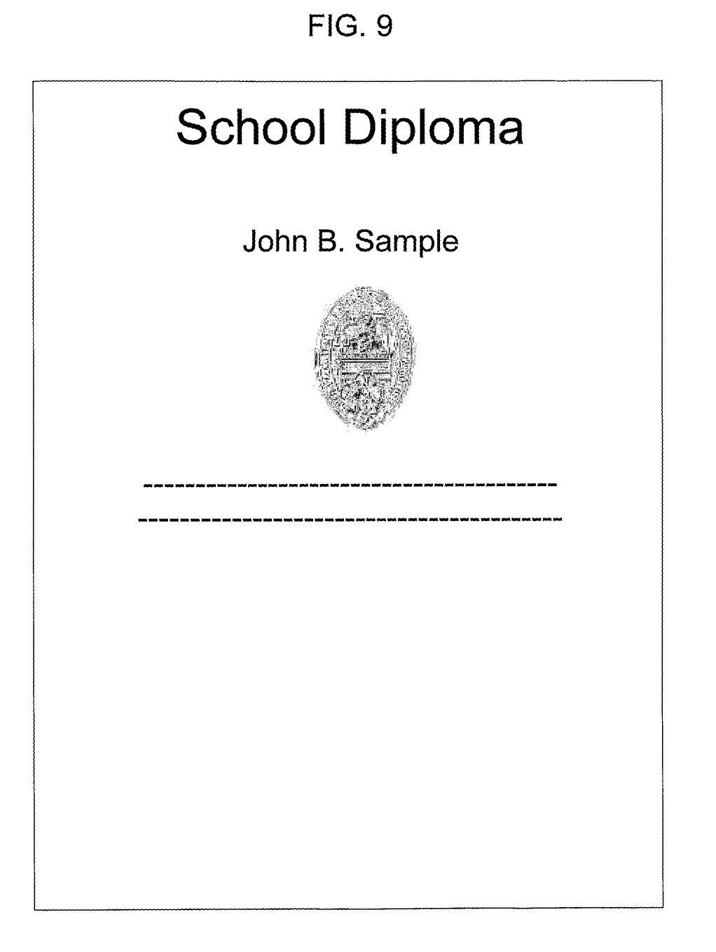

Documents which are uploaded to the repository's server 101 may be referred on hard copy documents as shown but not limited to, the following examples:
paper photocopies of documents distributed to users who may wish to authenticate the provenance of the original document, may include instructions as to how to view a certified copy online. For example, the owner may insert the following text to the photocopy: “Please see a certified copy of this document at: www.swisscertified.com/20001.pdf (password 1A236) or “To view a certified copy of this document please visit www.swisscertified.com (Document: 20001 Password: 1A236)”. An example of this approach is illustrated in FIG. 9.
In letters, resumés, CV's and brochures which are printed on paper a text only message referring to the uploaded document may be inserted. For example: “Please see a certified copy of my high school diploma at www.swisscertified.com (Document: 20001 Password: 1A236)”.

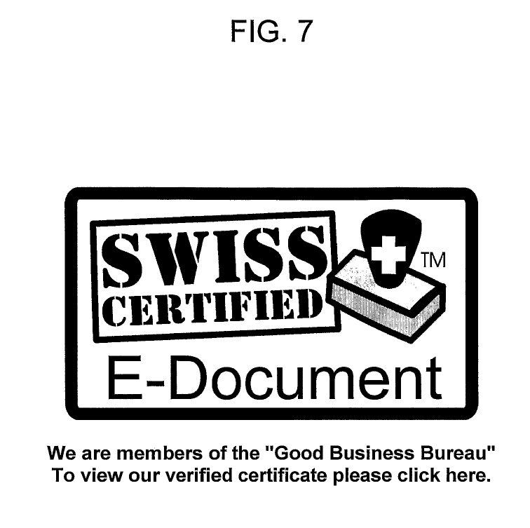

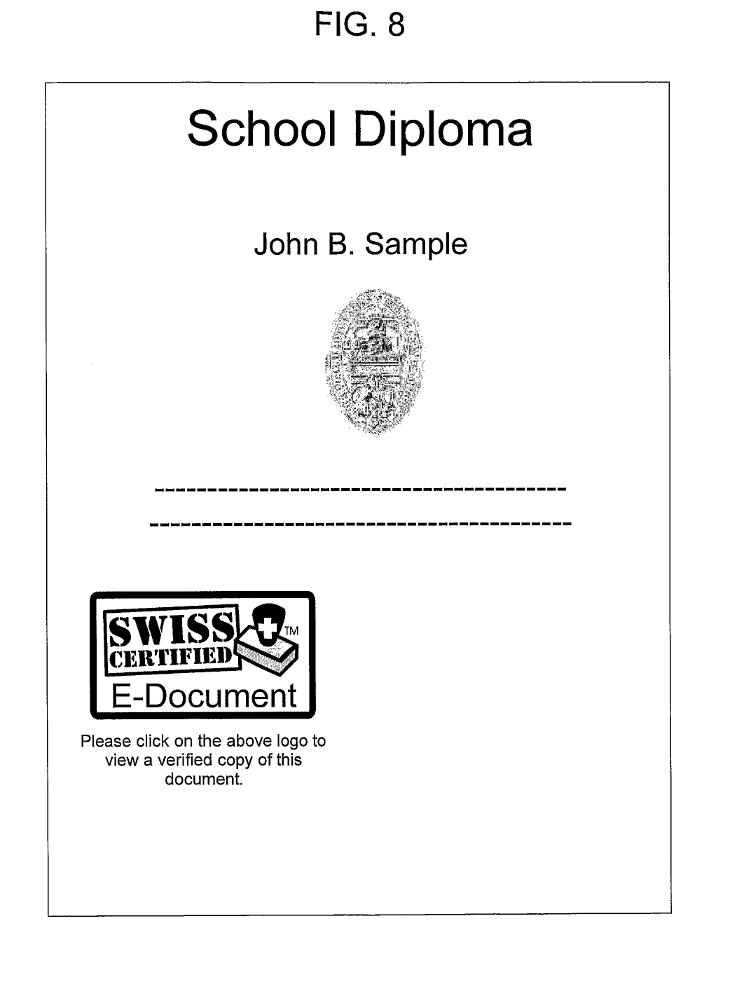

Documents on the repository's server 101 may also be referred to from electronic pages. For example electronic pages stored on web-sites or on removable media such as compact discs may refer to documents stored at the website of the repository 100. This is useful for internet based businesses who wish to establish their credentials in an online environment, such as, websites that sell products and services. This would include online auction sellers who can refer to trust building documentation stored at the repository's website from their auction listings. The present invention will also be useful for persons who wish to establish their identity and credentials in an online environment such as, for example, those looking for a partner using an online dating service. The electronic pages which refer to documents stored at the repository web-site may be in formats including HTML, PDF, MSWORD and as well as others. An effective method to access documents on the repository's server from electronic pages is to use hyperlinks. For example, a hyperlink may be created between an electronic page to the homepage of the repository 100 on the website hosted by the server 101 or, if the document is stored in a separate file on the server, the hyperlink may be linked to the URL of the file containing the document. The creation of hyperlinks within HTML pages, PDF documents, and MSWord documents is well known in the art. Examples follow which illustrate the aforementioned methods:
In a “text only” email message the owner writes: “Please see a notarized copy of my high school diploma at www.swisscertified.com (Document: 20001 Password: 1A236)”.
In a “text only” email message the owner writes: “Please click on the following hyperlink to see a notarized copy of my high school diploma: www.swisscertified.com (Document ID: 20001)”. The URL is linked to the home page of the repository's server where there is a user interface which includes a field where the user can enter the document id in order to open the selected document file.
In a “text only” email message the owner writes: “Please click on the following link to see a Swiss Certified copy of my high school diploma”. The hyperlink is linked to the URL of the document file: “http://www.swisscertified.com/upload/20001.pdf”.
An internet auction seller includes the following text message on auction listings or on web pages of the seller's website: “To view a Swiss Certified copy of my Automobile Seller's License CA please visit www.swisscertified.com (Document: 20001).
As illustrated in FIG. 7 an online business can include a logo and a text message on web pages such as, for example, auction listings. For example: “We are members of the Good Business Bureau. To view our verified certificate please click here. “The logo graphic and text message may be linked to the URL of the PDF file containing the document with a hyperlink.
As illustrated in FIG. 8 an electronic page such as a web page can have an image of the document as well as a graphic logo from the repository 100 with the message. “Swiss Certified EDocument”. A text message is also included: “Please click on the above logo to view a verified copy of this document.” These both link the logo graphic and the text message to the URL of the PDF file on the repository's server where the document and accompanying verification information is stored. For example: http://www.swisscertified.com/upload/20001.pdf.

### EXAMPLE 1

Further information about how the present invention can be used by consumers can be seen from the following example. A person graduates from a university, receives a diploma and wants to find employment. The graduate visits the website of the repository 100 and purchases a document file which is in PDF format and is accessible on the repository's server 101 at: www.swisscertified.com/20001.pdf with client computers on the internet. The number “20001” is the document file's ID. The repository 100 also provides the graduate with a customer password, which is required by the repository when, for example, adding or removing documents from the document file.

The graduate pays US$ 50.00 for the installation of document file 20001.pdf which includes a one year hosting subscription for being accessible on the internet server 101 of the repository 100. The hosting subscription can be extended. File 20001.pdf consists of only a cover page with the contact information of the graduate.

After the installation of document file 20001.pdf, the graduate sends a notarized paper copy of the diploma to repository along with an order form which includes the document file ID 20001.pdf and customer password. The repository scans the diploma e.g. with scanner 103 and saves it as a PDF file. The repository 100 checks the authenticity of the notary's signature and seal applied to the copy. This may be carried out by making checks over the telephone with the notary and by checking the notary's credentials against a professional register of notaries. Alternatively, the signature and seal of the notary may already be known to the repository with a specimen original being held securely by the repository 100. In this way, the provenance of the copy document is assured, since the provenance asserted by the notary's seal and signature can be used to provide verification information for the original document itself, even though it is a copy. The repository then flags the notary's signature and seal with indicia 12 using the Adobe Acrobat stamp tool to provide verification information. The resulting PDF image is then appended to document file 20001.pdf which is on the web server 101. The repository 100 bills the graduate US$ 10.00 for the one page upload as well as US$9.00 for returning the paper document via registered first class mail to the graduate.

As illustrated in FIG. 9, the graduate adds a paper photocopy of the diploma to the resume or CV which is sent by mail to prospective employers. On the photocopy the graduate writes: “To view a verified copy of this document please visit: www.swisscertified.com (Document 20001)”.

As illustrated in FIG. 8, on a website intended to be viewed by prospective employers and the like, the graduate may create a web page with a description of their qualifications, together with an image of the diploma as well as a logo for the repository 100. The graduate also creates a hyperlink to the URL of the file containing the document on the repository's web server 101 “www.swisscertified.com/20001.pdf” so that when a user such as a potential employer wishing to authenticate the diploma clicks on the logo, document file 20001.pdf is opened.

The graduate can also prepare a resume as a PDF file and add hyperlinks to the URL of the file stored on the website hosted by the server 101. The graduate can then distribute the PDF file via email to prospective employers as an email attachment. The graduate can also distribute compact disks or CD's on which the PDF with hyperlinks is stored.

A potential employer upon receiving the CV of the graduate, in paper form, sees the photocopy of the diploma and visits the repository's website hosted by server 101, e.g. by using computer 301, and is presented with a web page with a form field where the document ID can be entered. After entering the document ID and pressing enter, document 20001.pdf is opened within the internet browser using the Adobe Acrobat Reader plug-in and the verified copy of the diploma and accompanying verification information can be viewed.

Another person who received the resume as an email attachment e.g. at computer 302, opens the PDF file attachment with Adobe Acrobat and clicks on the hyperlink to the URL of the document file, 20001.pdf on the repository server thereby opening the file and viewing the verified copy of the diploma.

Another person sees the graduate's listing on a web-site and clicks a hyperlink which is linked to the URL of document file 20001.pdf on the repository server 101 thereby opening it.

While the services of the repository may be sold directly by the central repository 100 to customers, agents or representatives may also be appointed by the central repository to sell the service to customers e.g. the repository agent 200 shown in FIG. 1. Representatives or agents 200 of the repository may include certification authorities such as, for example, public notaries and organizations which issue documents.

For example, public notaries can act as the agent 200 to provide a service to. their customers where, after they notarize documents, they send documents to the central repository for processing according to the method of the present invention. Also, organizations which issue documents such as, for example, schools which issue diplomas may act as agent 200 to provide a service to their students whereby they send such documents to the central repository 100.

The representative or agent 200 of the repository may either physically send documents to the central repository 100 or transmit images electronically to the repository using for example, fax or email using the facsimile machines 201 and 104, or the scanner 202 and computer 203 as previously described. It is preferable that documents are transmitted electronically to the repository 100 rather than physically sending documents since this speeds up the process. Examples follow which illustrate how the method of the present invention may be incorporated when the central repository works with representatives.

### EXAMPLE 2

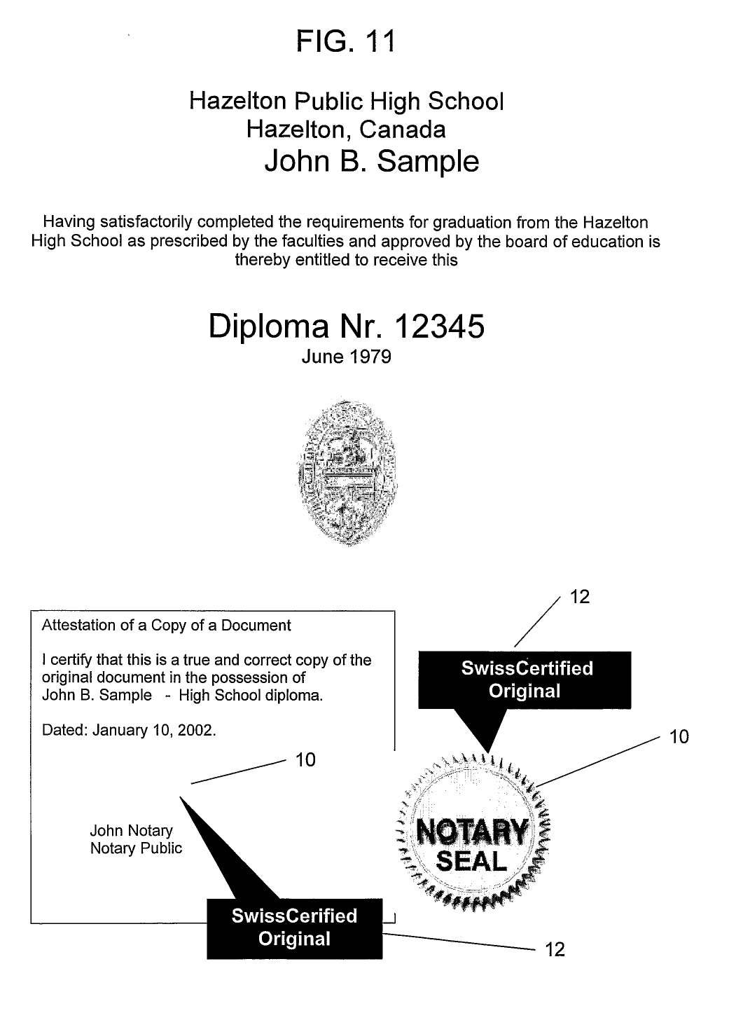

After receiving a document which has been faxed by a notary who is the representative 200, the repository 100 inserts indicia 12 into the document image, so as to provide verification information for marks 10 which were applied by the notary who faxed the document. FIG. 11 illustrates a diploma which was transmitted by fax to the central repository 100 by a notary who is a representative of the repository and whose notary marks have been flagged by indicia 12 in the document. Since the notary 200 is a representative or agent of the central repository 100, the notary's signature, seal, trustworthiness and authenticity is known to the repository. Therefore, the marks 12 can validly be applied to the copy document. Furthermore, the repository 100 can be confident of the provenance of the original document because it trusts the notary, as its representative or agent, only to notarize a true copy. As previously described the facsimile transmission may have an associated unique code to authenticate that it was sent by the agent, to authenticate the source of the fax transmission. Alternatively, the document may be emailed as previously described. The image data for the document including the flags 12 are then uploaded to the server 101 onto the website of the repository 100, for access by users 301, 302 through the internet 400 for authentication purposes, as previously described. A timestamp corresponding to the time that the image data was uploaded is also included in the document displayed through the website.

Together with the document, the central repository 100 (Wyssen Systems International in this example) also uploads a page with verification information which includes the contact information of the notary as well as a declaration by the central repository with the following text: “Wyssen Systems International (SwissCertified Division) of Zurich, Switzerland, hereby makes the following declaration of certification for the document stored in this protected file:
1) The enclosed document was notarized by the above named certification authority who is an official agent of Wyssen Systems.
2) The enclosed document was transmitted directly to us by above named certification authority using either fax or email. The above named certification authority being identified as the sender with a unique code which was transmitted along with the enclosed document.
3) The enclosed document has not been altered since the official time stamp at the top of each document page.
4) Signatures, stamps and seals marked “SwissCertified Original” were applied by the above named certification authority to the enclosed document.”

### EXAMPLE 3

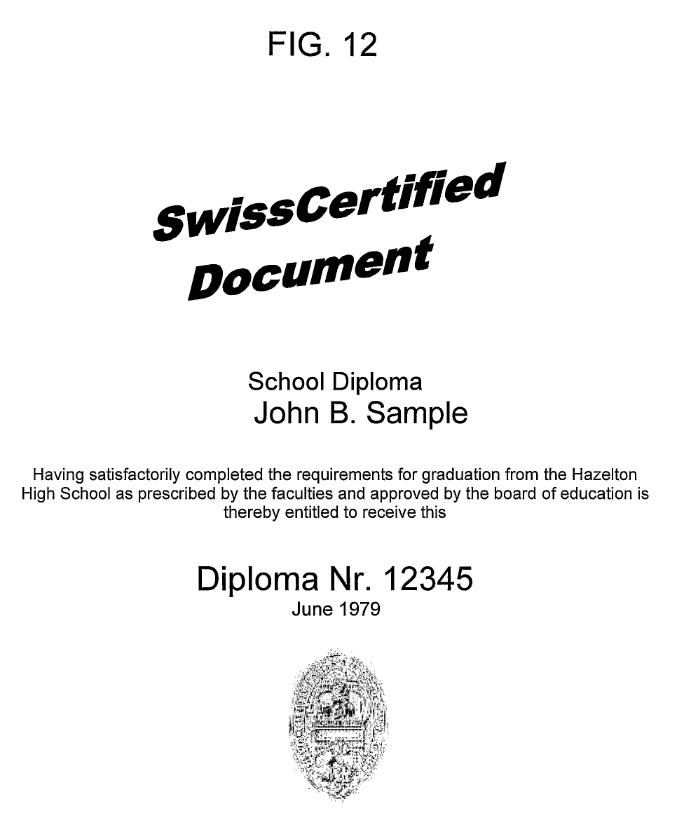

In this example a school which issued a diploma to a student is an agent 200 of the repository 100. The diploma is faxed or emailed to the repository 100 by the school which issued the document, in the same way as described with reference to Example 2. The repository 100 inserts the text “Swiss Certified Document” onto the document image which is uploaded to the server 101 to be made available to users for authentication through the internet as described with reference to Example 2. A timestamp corresponding to the time that the image data was uploaded is also included in the document displayed through the website. FIG. 12 illustrates a diploma which was faxed to the central repository 100 by a representative 200, a school, and to which the verification information “Swiss Certified Document” was added. Together with the document, the central repository 100 also uploads to the server 101 a page with verification information for access by users wishing to authenticate the document. The verification information includes the contact information of the school as well as a declaration of certification by the central repository with the following text: “Wyssen Systems International (Swiss Certified Division) of Zurich, Switzerland, hereby makes the following statement for the document stamped “Swiss Certified Document” stored in this protected file:
1) The enclosed document stamped “Swiss Certified Document” was issued by the above named certification authority who is an official agent of Wyssen Systems.
2) The enclosed document was transmitted directly to Wyssen Systems by the above named certification authority using either fax or email. The above named certification authority being identified as the sender with a unique code which was transmitted along with the enclosed document.
3) The enclosed document has not been altered since the official time stamp at the top of each document page.”

In the afore-mentioned Examples 2 and 3, since the central repository 100 does not examine the original document when transmitted electronically, various safeguards are preferably built into the system in order to make sure that the document is transmitted by the representative of the repository, who also acts as the certification authority for the uploaded document. These may include one or more from the following list:
Each time documents are sent electronically to the repository by an agent, a cover page is included which includes one or more unique passwords known only by the trusted agent and the repository.
Documents may be sent to a secret fax number only known to the trusted agent.

The following example illustrates a 3-step procedure which may be used by the central repository 100 when working with representatives 200 including, for example, public notaries and schools.

Step 1 of 3:

The repository 100 delivers transmittal cover pages to representatives 200 which are used when electronically transmitting documents to the central repository, such as, for example, when faxing. One cover page is used each time one or more documents are transmitted for a customer to the central repository. Cover pages may be delivered to the agents as paper hard copy pages or as electronic data files such as, for example, in the PDF format, which are then printed out on paper sheets by the agent. After transmitting documents along with the cover page to the repository, it is preferable that the cover page be given to the customer along with documents transmitted. Transmittal cover pages may include one or more items from the following list:
A unique code which becomes the document ID and also enables the repository to identify the representative transmitting the document.
A place where a password for opening the document to be accessed through the website (open password) can be given if the customer wants this.
The identity of the representative or agent 200 of the repository 100 along with contact information.
A place where the contact information of the customer can be entered.
An owner or master password which the customer can give the repository 100 when deleting the document file or making other changes such as, for example, changing or adding a password.
Detailed customer instructions in using the service.
Instructions on how to extend the hosting subscription.

An example of the text on a cover page follows:
“Your File's ID is: abc2
Open Password (optional): ______
Open Password: You can give a password in order to allow only selected persons to open your document. In many cases a password is not necessary. If you do not want a password leave blank.

Swiss Certified File Information:

Within 24 hours your document will be able available for online verification at this internet address: http://www.swisscertified.com/docs/abc2.pdf or by visiting www.swisscertified.com and entering your file ID: abc2 Your Master Password is: 235674 (Please do not give this password to anyone since it is only required by us if you make changes to your file, such as when changing or adding an open password or deleting your document file.)

Customer Instructions:
1) For web-pages, online auction listings, as well as files (e.g. Word, PDF) on removable media such as CD's, create a hyperlink to the URL (internet address) of your Swiss Certified document file (see above). For example you may link a text message such as: “Please click here to view of certified copy of my diploma.”You may also place the text message over an image of your document and then link to your Swiss Certified file. If creating a hyperlink is not possible, simply use a text message such as: To view a certified copy of my diploma please visit www.swisscertified.com (document: abcd password: test).”
2) On paper hardcopy such as printed letters, brochures and photocopies you can include a message such as: “To view a certified copy of my diploma please visit www.swisscertified.com (document: abcd password: test)”. You can also print the text on a photocopy or fax of your document.
3) Your document will be available for online verification at swisscertified.com for a period of 6 months. You can renew your hosting subscription for additional 6-month periods by visiting www.swisscertified.com and following the instructions under “customer support”.

For further instructions please visit: www.swisscertified.com. If you have any questions you may either ask our agent or contact us at: Wyssen Systems International, Swiss Certified Division, Schweighofstrasse 405a, 8055 Zurich Switzerland. Tel. + 411 4508560 Fax + 411 4508561. Email: contact@swisscertified.com. www.swisscertified.com”

The following is an example of a text message with instructions that the central repository can give its representatives when delivering one or more transmittal cover pages in a data file:
“1) Print out this entire file and then delete it in order to prevent it from being printed twice!
2) For security reasons, all documents must faxed to us by you and NOT the customer.
3) Please fax the cover page along with the document to our document fax number: 050 1212 12 12 12 (This number is confidential and not be given to customers). If you have any questions please contact us at: Wyssen Systems International, Swiss Certified Division, Schweighofstrasse 405a, 8055 Zurich, Switzerland. Tel. + 41 1 450 85 60. Fax + 41 1 450 85 61 Email: contact@swisscertified.com. www.swisscertified.com”.

Step 2 of 3:

The representative 200 sells the service to its customers. For example, if the representative is a notary, a sign with the following text may be used: “Your notarized documents can now be verified online. No need to send the original notarized paper document. Send a photocopy, fax or email instead and let people verify online. Price: Only $12.95 per page. Your document will be available at SwissCertified.com for online verification for 6 months (can be extended)”.

Step 3 of 3:

At the end of each month or after a fixed number of uploaded pages the central repository 100 invoices its representatives 200 for each uploaded page. For example, $3.00 per page. The repository can charge its representatives a low price since in many cases customers will choose to renew their hosting subscriptions and the repository will charge the customers directly.

Many modifications and variations to this approach are possible. For example the uploading of documents such as graduation certificates to the server 101 may be provided as a free service by academic institutions such colleges and universities, when acting as an agent 200, for a limited period. Thereafter, if a graduate of the institution wishes to keep the certified copy of their graduation certificate available through the server 101 during a period of job hunting, then the graduate pays a subscription to the repository 100 or the agent 200. Reference to the certificate on the website of the repository can then be included in the graduate's resume to allow potential employers to authenticate the original document. The initial free service encourages adoption of the service by customers such as new graduates.

### EXAMPLE 4

In this example, consumers can visit a notary or institution of their choice to certify an original document and then send the certified copy to the repository 100 by facsimile or email as previously described. Thus, in this example, the agent 200 comprises a notary or institution selected by the consumer, that may or may not be already known to the repository 100. If not known to the repository, the repository 100 carries out checks to determine the authenticity of the agent 200.

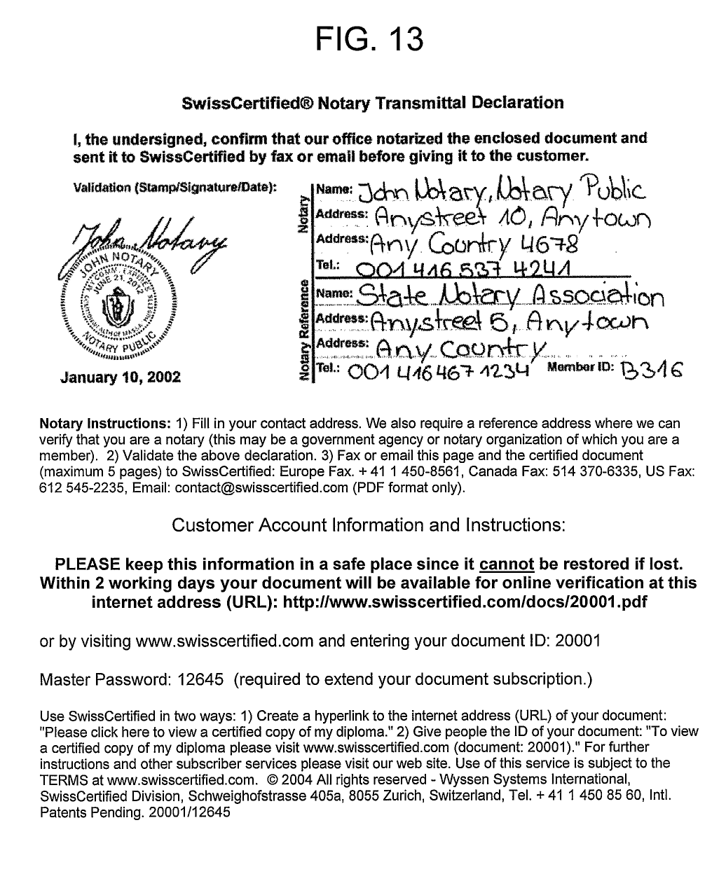

The following steps are carried out:
(1) a consumer visits the website of the repository 100 and prints out a transmittal sheet for the certified copy of the original document. A example is shown in FIG. 13.
(2) The consumer visits a notary of the consumer's choice with an original document to be certified and the transmittal sheet. The notary agrees to prepare a certified copy of the original document and generally to act as the agent 200.
(3) The notary then prepares a certified copy of the original document, fills out and validates the transmittal declaration on the sheet shown in FIG. 13, and then faxes or scans and emails the completed transmittal declaration and the certified copy to the central repository 100.
(4) The repository then checks the bone fides of the notary who sent the documents, by checking the notary's details against any available official registers, and if appropriate by making telephone calls to the notary or official bodies to check the accreditation of the notary.
(5) Assuming that the repository 100 is satisfied with the provenance of the documents, they are uploaded by the repository 100 to the repository's website for access by users 301, 302 who want to authenticate the original document in the manner previously described in the earlier examples. The transmittal form completed by the notary provides provenance information for the certified copy of the original document. Furthermore, the documents may be accompanied by further provenance information provided by the repository 100. For example, the repository may provide a statement that (a) the repository certifies that the documents were sent directly by the named notary to the repository and that (b) the authenticity of the notary 200 has been checked by the repository 100.

The documents can be accessed from the website as previously described in the earlier examples and the documents may be made available for a trial period at no cost to the consumer, after which a payment is required e.g. by means of a credit card to continue to have the documents accessible through the website of the repository 100.

As can be seen from the foregoing examples, the invention is useful in establishing trust in online communications where the inherent anonymity of the Internet has resulted in a huge increase in fraudulent activities. For example, using the method of the present invention allows businesses to make available their credentials and qualifications much as brick and mortar businesses do by hanging certificates, diplomas and the like on the walls of their establishments thereby attesting to their qualifications. An example of this is the doctor's diploma in the waiting room, the vehicle sales permit which hangs in an automobile salesman's office, the ISO Certification which hangs in the offices of manufacturing companies and so on. The present invention also saves money for people since they no longer have to send original certified documents but rather can send a fax, electronic document or photocopy of their document instead and people can verify the document online. The present invention also speeds up the verification process since documents can be verified online rather then by physically transporting paper documents.

In the foregoing specification, the invention has been described with reference to specific embodiments thereof. It will, however, be evident that various modifications and changes may be made thereto without departing from the scope of the invention as defined in the following claims. The specification and drawings are, accordingly, to be regarded in an illustrative rather than a restrictive sense.

1. A computer system accessible remotely by a user to authenticate a document, comprising:
a memory configured to store electronic image data corresponding to an original document having a verifiable provenance, and separately derived electronic displayable verification information corresponding to the provenance of at least part of the original document, and
an output configured to provide said image data and said verification information for display by the user to authenticate the original document.

2. A computer system according to claim 1 wherein the image data has been obtained from an authenticated source, and the verification information includes data corresponding to the provenance of the authenticated source.

3. A computer system according to claim 1 wherein data is fed to and from the memory under the control of a repository.

4. A computer system according to claim 3 wherein the verification information comprises data concerning the provenance that has been subjected to authentication by the repository, and the verification information being configured to signal to the user that the repository provides such authentication.

5. A computer system according to claim 2 wherein data stored in the memory cannot be altered by users.

6. A computer system according to claim 3 including apparatus to receive the image data from a remote location.

7. A computer system according to claim 1 including a scanner for scanning an original document to produce said image data.

8. A computer system according to claim 1 including a repository agent including apparatus operable to send image data corresponding to an original image to the repository.

9. A computer system according to claim 8 wherein the repository agent is operable to send the image data together with source authentication information to indicate to the repository that the image data has been sent from the agent.

10. A computer system according to claim 1 wherein the verification information comprises predetermined accreditation indicia to be viewed by a user concurrently with the image data for authenticating individual parts of the original document.

11. A computer system according to claim 1 wherein the verification information comprises accreditation data to be viewed by a user in a separate field associated with the image data for authenticating the original document.

12. A computer system according to claim 1 wherein the image data and the verification information are stored in a common electronic file.

13. A computer system according to claim 12 wherein the file is a PDF file.

14. A computer system according to claim 1 including a server providing said memory and operable to host a website at which said image data and verification information is viewable by a user to authenticate the original document.

15. A computer system according to claim 1 wherein said output is connected to the Internet.

16. A computer system according to claim 1 wherein said image data and verification information in the memory is password protected so that the user can only gain access thereto by use of the password.

17. A computer system according to claim 1 wherein the image data and the verification information corresponding to the original document when stored in the memory collectively has an individual addressable identity.

18. A method of operating a computer system according to claim 1 to provide said image data and said verification information for display by the user to authenticate the original document.

19. A method of displaying a document for authentication, comprising
creating electronic image data corresponding to an original document having a verifiable provenance,
providing electronic, displayable verification information corresponding to the provenance of at least part of the original document, and
displaying the image data and the verification information, to permit a user to authenticate the document.

20. A method according to claim 19 including receiving the image data from an authenticated source, storing the image data for display, and creating the verification information for the received image, wherein the verification information includes data corresponding to the provenance of the authenticated source.

21. A method according to claim 19 including authenticating the source of the image data.

22. A method according to claim 18 including feeding the image data and the verification information to a memory under the control of a repository for display to users wishing to authenticate the original document.

23. A method according to claim 22 wherein only the repository can change the data in the memory.

24. A method according to claim 22 wherein the verification information comprises data concerning the provenance that has been authenticated by the repository.

25. A method according to claim 24 wherein the repository communicates with the source of the image data to determine the provenance thereof and to develop said verification information.

26. A method according to claim 22 including feeding the image data to the repository from a remote location.

27. A method according to claim 22 including sending send image data corresponding to an original image from a repository agent to the repository.

28. A method according to claim 26 including sending the image data together with source authentication information to indicate to the repository that the image data has been sent from the repository agent.

29. A method according to claim 18 including configuring the verification information to include predetermined accreditation indicia viewable concurrently with the image data for authenticating individual parts of the original document by a user that authenticates the document.

30. A method according to claim 18 including configuring the verification information to comprise accreditation data to be viewable by a user in a separate field associated with the image data for authenticating the original document.

31. A method according to claim 18 including storing the image data and the verification information are stored in a common electronic file.

32. A method according to claim 18 including storing the image data and the verification information are stored in a common electronic PDF file.

33. A method according to claim 18 including hosting a website at which said image data and verification information is viewable by a user to authenticate the original document.

34. A method according to claim 18 including authenticating the original document by viewing said electronic image data and the corresponding verification information.

35. A method according to claim 18 wherein said image data and verification information is password protected so that a user can only gain access thereto by use of the password, and including supplying the password to a user to permit the user to authenticate the original document.

36. A method according to claim 18 wherein the image data and the verification information corresponding to the original document collectively have an individual addressable identity and including supplying the individual addressable identity to a user to permit the user to access the data and information for authenticating the original document.

37. A method according to claim 35 including supplying a hyperlink to the user.

38. An electrical signal for displaying a document for authentication to be received by a client computer operated by a user who wishes to authenticate the document, comprising:
electronic image data corresponding to an original document having a verifiable provenance, and
electronic, displayable verification information corresponding to the provenance of at least part of the original document.
